(19) United States
(12) Patent Application Publication
(10) Pub. No.: US 2004/0158537 A1
(43) Pub. Date: Aug. 12, 2004

(54) Network marketing compensation system

(76) Inventors: Aaron John Webber, Orem, UT (US); Glenn Paulo Bangerter, American Fork, UT (US); Troy Jens Pugh, Orem, UT (US)

Correspondence Address: Charles L. Roberts, WORKMAN NYDEGGER & SEELEY, 1000 EAGLE GATE TOWER, 60 EAST SOUTH TEMPLE, SALT LAKE CITY, UT, 84111, US

(21) Appl. No.: 10/128,646

(22) Filed: Apr. 22, 2002

Related U.S. Application Data
(60) Provisional application No. 60/285,508, filed on Apr. 20, 2001.

(51) Int. Cl. G06F 17/00

(52) U.S. Cl. 705/400

(57) ABSTRACT

The sales compensation plan of the present invention is a stair-step compensation plan without a breakaway to promote depth as well as breadth within the distributor's distribution genealogy. The compensation plan also includes an advanced performance team position that enables qualifying distributors to position themselves within their own frontline of their distribution genealogy to receive additional compensation for their efforts. Yet another feature of the compensation plan is the unique concept of horizontal compression for enabling leg volume requirements to be satisfied by horizontally compressing the leg volume of a plurality of legs.

### RELATED APPLICATIONS

This application claims the benefit of U.S. Provisional Patent Application Serial No. 60/285,508, entitled “Network Marketing Compensation System,” filed Apr. 20, 2001, which is incorporated herein by reference.

### BACKGROUND OF THE INVENTION

1. The Field of the Invention

The present invention is in the field of business methods for compensating distributors in direct sales organizations and, more particularly, to business methods for compensating distributors in multi-level compensation plans.

2. The Relevant Technology

In the industry of direct sales organizations, there are several different types of compensation plans. Some of the more popular compensation plans include direct sales, multi-level, and network compensation plans, each having their own advantages and disadvantages.

Direct sales plans promote direct one-on-one selling by limiting any personal sales organization to one or two pay levels. Each pay level is a level in which the distributor or seller is compensated for sales made directly by the distributor. Although direct sales compensation plans are useful for fostering good personal relationships between the distributor and the buyers, direct sales compensation plans are not very good for developing large sales organizations. In particular, direct sales compensation plans generally provide a disincentive for recruiting new distributors to the company inasmuch as any new distributors become direct competitors of the existing distributors. Further, distributors are generally not compensated for recruiting new distributors into the company.

Direct sales plans, thus, act to encourage the distributor to emphasize the product and the distributor's personal sales rather than to promote recruiting, training and managing a personal sales organization that includes other distributors. People who are more comfortable with selling a product rather than recruiting, managing and training other people often prefer direct sales plans. As a consequence of these factors, organizations that utilize direct sales plans tend to develop slowly.

Multi-level plans such as uni-level and matrix compensation plans reward distributors for developing a large personal sales organization (i.e. “distribution genealogy”), which includes a front line of personally sponsored distributors/representatives (i.e. “frontline distributors”) and one or more legs, where a leg includes a frontline distributor and a genealogy of additional downline distributors that descend from the frontline distributor. A leg is formed, for example, when the frontline distributor sponsors one or more downline distributors, who in turn each sponsor one or more downline distributors, etc. Accordingly, a distributor's distribution genealogy includes the distributor's frontline distributors and all downline distributors that descend from the frontline distributors.

Multi-level plans typically encourage the development of large distribution genealogies by paying commissions and bonuses on the purchases and sales made by certain downline distributors/representatives within the distributor's distribution genealogy. Multi-level plans are generally useful for encouraging a distributor to develop a deep genealogy or personal sales organization, thereby enabling a distributor to maximize its profits. This feature, generally thought to be an advantage of multi-level plans is also a disadvantage. The disadvantage arises because it is easier for the distributor to manage and train only a few frontline distributors, rather than to train many. Some multi-level plans even limit the number of personally sponsored distributors that can be placed within a distributor's front line. Accordingly, multi-level plans generally promote deep distribution genealogies. However, this is often done at the expense of developing wide distribution genealogies, which could otherwise accelerate the overall growth of the company.

Network compensation plans, such as the popular stairstep/breakaway plan, compensate a distributor based on some combination of personal sales volume and the total sales volume of the distributor's personal sales organization. In most network compensation plans, the distributor achieves rankings based on the performance and qualification of the distributor's sales organization. Accordingly, the company can modify the behavior of the distributor and the ultimate shape of the distributor's sales organization by modifying the requirements that are necessary to achieve a ranking.

In stairstep/breakaway compensation plans, the distributor is generally compensated for developing a deep distribution genealogy because the distributor receives compensation based at least in part on the total sales volume of the distributor's genealogy. However, when any leg of the distributor's distribution genealogy becomes independently qualified for a particular ranking then that leg will break away from the distributors network, thereby preventing the distributor from receiving further commissions based on that portion of the distributor's distribution genealogy. Accordingly, the distributor is thereby encouraged only to develop legs to the extent that they do not become independently qualified to break away from the distributor's organization. This is a significant problem with stairstep/breakaway plans. In particular, this discourages training and successful development of many downline members, which would otherwise benefit the overall growth and development of the company.

Accordingly, there currently exists a need in the art to develop a method for compensating distributors in a direct sales organization in which the distributors are encouraged to develop wide and deep distribution genealogy while at the same time promoting the individual success of each leg within the distributor's distribution genealogy.

### SUMMARY AND OBJECTS OF THE INVENTION

The present invention provides a network marketing compensation system for compensating distributors in a distribution network. The network marketing compensation system of the present invention is divided into three general compensation phases.

In the first phase, a distributor receives a personal rebate based on the distributor's personal volume, i.e., the unit amount of product the distributor purchases or sells during a month, as defined below in greater detail. The distributor also receives a commission based on the distributor's team volume, i.e., the distributor's personal volume combined with the distributor's front line volume, as further defined below. In the second phase, and upon meeting designated requirements, the distributor receives an override bonus. There are nine override bonus levels that are based on percentages of the personal volume of product that is acquired or sold by members within the distributor's distribution genealogy. The third phase comprises additional benefits, which are available by satisfying additional requirements. One particular benefit in the third phase includes an additional distributorship, referred to herein as an “additional performance team” position, that the distributor can place on the front line of the distributor's genealogy to receive additional bonuses. For enabling a distributor to satisfy the requirements of the second and third phases of the compensation plan, the present invention allows horizontal compression of leg volume within the distributor's genealogy, as explained below in greater detail.

The present invention is an improved network marketing compensation system over the prior art. The network marketing compensation system of the present invention rewards wide and deep distribution genealogies on various levels, while overcoming many of the problems associated with compensation plans of the prior art.

Additional objects and advantages of the invention will be set forth in the description which follows, and in part will be obvious from the description, or may be readily learned by the practice of the invention. The objects and advantages of the invention may be realized and obtained by means of the instruments and combinations particularly pointed out in the description. These and other objects and features of the present invention will become more fully apparent from the following description, or may be learned by the practice of the invention as set forth hereinafter.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates one presently preferred table of Phase I requirements and benefits of the compensation system of the present invention that includes minimum personal volume (PV) requirements and rebates;

FIG. 2 illustrates an exemplary distributorship genealogy that includes a distributor and seven members;

FIG. 3 illustrates presently preferred Phase I requirements and benefits of the compensation system of the present invention that includes minimum team volume (TV) requirements and commissions;

FIG. 4 illustrates presently preferred Phase II requirements and benefits of the compensation system of the present invention;

FIG. 5 illustrates a sample distributorship genealogy that includes a distributor, eleven downline members, and three generations that are determined according to Phase II compression rules of the present invention;

FIG. 6 illustrates presently preferred Phase III requirements and benefits of the compensation system of the present invention;

FIG. 7 illustrates a diagram of a distributorship genealogy having seven legs and an additional performance team position (APT); and

FIG. 8 illustrates a diagram of the distributorship genealogy of FIG. 7 in which two of the seven legs have been placed under the APT and in which the distributor has occupied the APT.

### DETAILED DESCRIPTION OF THE PREFERRED EMBODIMENTS

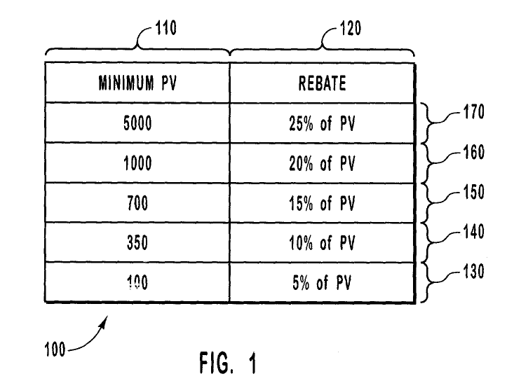

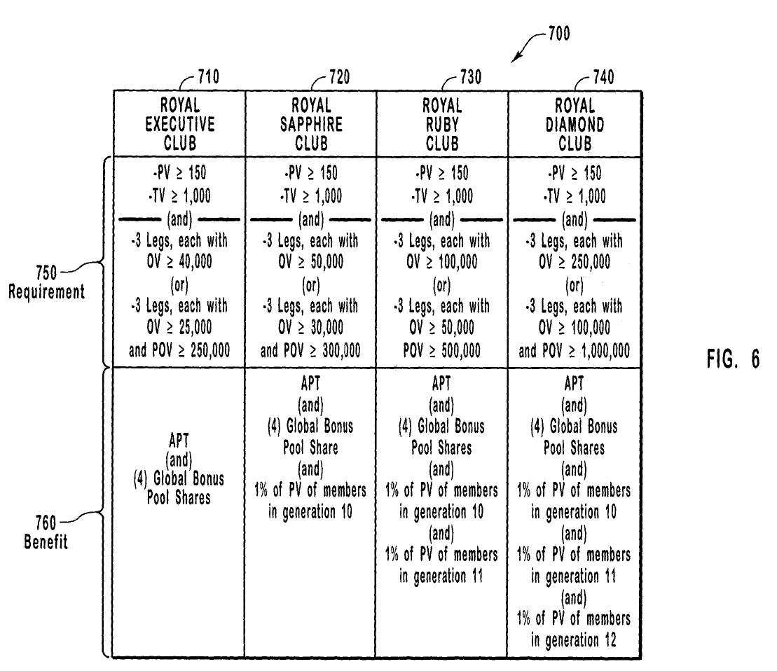

The present invention relates to a network marketing compensation system for compensating a distributor within a distribution network. The network marketing compensation system of the present invention is generally described herein in terms of three compensation phases. Qualification for compensation within each of the three phases is based on the personal performance of an individual distributor and upon the results of the distributor's leadership and management in creating a distribution genealogy. The three general phases of the invention are discussed herein in reference to FIGS. 1-8.

### PHASE I COMPENSATION

Phase I of the compensation plan of the present invention comprises a personal rebate and a commission. The personal rebate is based on a percentage of a distributor's personal volume, hereinafter “PV,” which is defined herein as the total commissionable volume of product that a distributor purchases for personal consumption or resale combined with the commissionable volume of product purchased by retail customers on the distributor's account within a given volume month. PV is generally equivalent to money spent and may or may not be expressed in units of money. Although in this preferred embodiment, PV is referred to as a monthly quantity, one of skill in the art will readily appreciate that PV could be based on virtually any period of time. The term “product” should be broadly construed to include any good, service, or other benefit that can be marketed by a network marketing company and purchased or sold by a distributor of that company. The term “distributor” should be broadly construed to include any individual, group, corporation, party, or other entity that has contracted with the company to sell products of the company to others or purchase products for personal consumption. Such distributors will generally be independent contractors to the company.

In a preferred embodiment illustrated in FIG. 1, a table 100 illustrates the relationship between minimum PV 110 and a distributor's rebate 120. Thus, a distributor qualifies for a rebate 120 in any month in which the distributor's PV reaches or exceeds designated PV requirements 110. For example, if a distributor's PV is at least 100, then the distributor is qualified to receive a first-level rebate 130 comprising a monetary equivalent of 5% of the distributor's PV. If a distributor's PV is at least 350, then the distributor is qualified to receive a second-level rebate 140 comprising a monetary equivalent of 10% of the distributor's PV. If a distributor's PV is at least 700 then the distributor is qualified to receive a third-level rebate 150 comprising a monetary equivalent of 15% of the distributor's PV. If a distributor's PV is at least 1,000, then the distributor is qualified to receive a fourth-level rebate 160 comprising a monetary equivalent of 20% of the distributor's PV. If a distributor's PV is at least 5,000 then the distributor is qualified to receive a fifth-level rebate 170 comprising a monetary equivalent of 25% of the distributor's PV. It should be appreciated that although PV is expressed in terms of integer units, rebates are paid in units of money. For example, according to the preferred embodiment of FIG. 1, if a distributor has a PV of 2,000 then the distributor will receive a rebate comprising a monetary equivalent of 20% of 2,000, or $400.

These monthly rebates, as they have been described, are mutually exclusive. In other words, even if a distributor is qualified for every level of monthly rebates, the distributor will only receive a single monthly rebate, which will be the highest rebate that the distributor is qualified to receive. For example, if the distributor has a PV of 5,000, the distributor will only receive a monthly rebate comprising a monetary equivalent of 25% of the PV, which is $1,250. It should be appreciated that the distributor will not receive each of the other rebates that the distributor is qualified to receive. One of skill in the art will appreciate that the minimum PV qualification levels 110 may be set for a variety of different thresholds and that the rebate percentages 120 associated with a particular qualification level may also be set according to a variety of factors to suit the needs of the company implementing the compensation plan of the present invention.

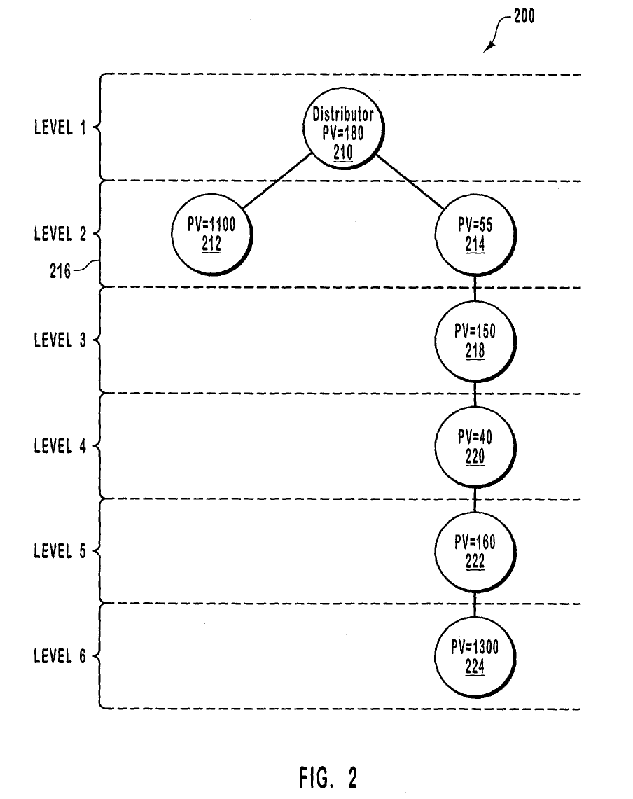

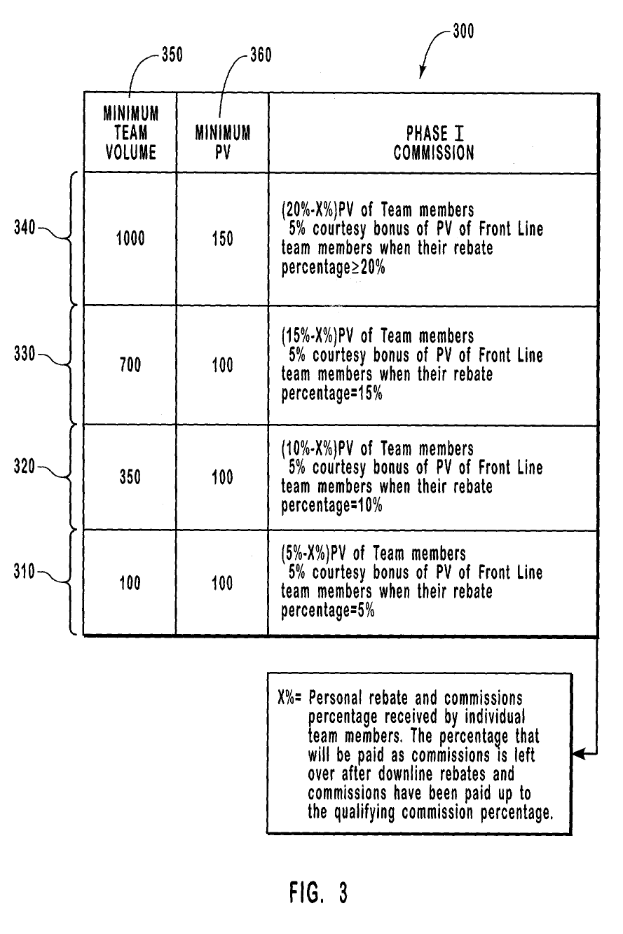

As mentioned earlier, the distributor can also qualify for a Phase I commission in addition to a rebate. To determine the level of a commission the distributor is eligible to receive, if any, it is first necessary to determine the distributor's team volume (“TV”), which will be generally described in reference to FIGS. 2 and 3.

FIG. 2 shows a distributor genealogy 200 comprising six levels. Distributor 210 is located in the first level and the distributors positioned in levels 2 thru 6 comprise the descendants of distributor 210. Downline distributors 212 and 214 are distributors that have been personally sponsored by the distributor 210 and are included in the front line 216 of distributor 210. Thus, distributor 210 is said to be the “sponsor” of distributors 212 and 214. Distributor 218 is a descendant of distributor 214, distributor 220 is a descendant of distributor 218, distributor 222 is a descendant of distributor 220, and distributor 224 is a descendant of distributor 222. The various distributors in a genealogy such as that illustrated in FIG. 2 are variously referred to herein as “distributors,” “members,” or “positions.”

The compensation system of the present invention bases a distributor's compensation on the performance of the distributor and the downline of that distributor. As used herein, the term “top-line distributor” refers to the distributor for which compensation is being calculated. In FIG. 2, the top-line distributor is distributor 210. It will be appreciated however, that in practice, distributor 210 and its downline may be part of a much larger distributor network.

A top-line distributor's TV, which is used to compute the Phase I commission, comprises the sum of (1) the distributor's PV, and (2) the distributor's front line volume (“LV”). As used herein, the LV is defined to include the PV of every distributor that is personally sponsored by the top-line distributor, or in other words, those distributors found in the top-line distributor's first level. Additionally, when a personally sponsored distributor is unqualified, i.e., has a PV of less than 100, then the LV is also defined to include the PV of every distributor that falls downline from that unqualified front line distributor, down to and including the PV of the first qualified position that is encountered in that downline.

For example, the LV of distributor 210 of FIG. 2 comprises the sum of the PV of every member on the distributor's front line 216, which includes the PV of distributor 212 and the PV of distributor 214. Because distributor 214 is unqualified, having a PV of only 55, the LV of distributor 210 also includes the PV of every distributor that is downline from unqualified distributor 214, down to and including the first qualified downline distributor that is encountered. In this example, distributor 218 is the first encountered downline distributor that is qualified, having a PV of 150. Accordingly, the LV of distributor 210 includes the PV of distributor 212 (PV=1,100), the PV of distributor 214 (PV=55), and the PV of distributor 218 (PV=150), for a total LV of 1,305.

The TV of distributor 210 is finally computed by summing the PV of distributor 210 (PV=180) with the LV of distributor 210 (LV=1,305) for a total TV of 1,485. Once the distributor's TV has been determined, it is possible to calculate the distributor's Phase I commission according to the teachings of the present invention. In one presently preferred embodiment, shown in FIG. 3, the Phase I commission is computed according to table 300 in which a distributor qualifies for a monthly commission when the distributor's TV reaches or exceeds designated minimum amounts.

According to this presently preferred embodiment, the distributor's Phase I commission comprises a percentage of the PVs that are included in the calculation of the distributor's LV. The percentage that is paid out to the top-line distributor for each team member's PV is a function of both the top-line distributor's TV and the total amount of rebates and commissions that have already been paid out to team members. Team members are front-line distributors that contribute PV to the calculation of the top-line distributor's LV. For example, with reference to FIG. 2, distributors 212, 214, and 218 are classified as team members because their PV was included in the calculation of the LV of distributor 210. According to another embodiment, a distributor may also receive a commission on all distributors within the top-line distributor's first generation, as defined and described below.

As shown in FIG. 3, there are four different Phase I commission levels 310, 320, 330, and 340, each of which can be obtained by satisfying the minimum team volume requirements 350 and minimum PV requirements 360. For example, if a distributor has a PV of at least 100 and a TV of at least 100 but less than 350, then the distributor is qualified to receive a first-level, Phase I commission 310 comprising a monetary equivalent of (5%-X%) the PV of each team member, wherein X% comprises the rebate percentage plus the commission percentages, if any, that have already been paid to qualified team members. For example, if a team member has a PV of 100, thereby qualifying for a 5% personal rebate according to table 100 of FIG. 1, then the Phase I commission payable to the top-line distributor will be a monetary equivalent of (5%-5%) of 100, or $0.00. However, according to this present example, since the team member has already received a personal rebate of 5%, then the distributor will qualify to receive a “courtesy bonus” comprising a monetary equivalent of 5% of the PV of that team member. Additional qualifications for entitlement to the courtesy bonus are set forth below.

If a distributor has a PV of at least 100 and a TV of at least 350 but less than 700, the distributor is qualified to receive a second-level, Phase I commission 320 comprising a monetary equivalent of (10%-X%) of the PV of each team member. Additionally, if a team member has already received a personal rebate of 10%, then the distributor qualifies for a monetary equivalent of 5% courtesy bonus of the PV of that team member.

If a distributor has a PV of at least 100 and a TV of at least 700 but less than 1,000, the distributor is qualified to receive a third-level, Phase I commission 330 comprising a monetary equivalent of (15%-X%) of the PV of each team member. Additionally, if a team member has already received a personal rebate of 15%, then the distributor qualifies for a courtesy bonus comprising a monetary equivalent of 5% of the PV of that team member.

Finally, if a distributor has a PV of at least 150 and a TV of at least 1,000 then the distributor is qualified to receive a fourth-level, Phase I commission 340 comprising a monetary equivalent of (20%-X%) of the PV of each team member. If a team member has already received a personal rebate of at least 20%, then the distributor qualifies for a courtesy bonus comprising a monetary equivalent of 5% of the PV of that team member.

In a presently preferred embodiment, a distributor only qualifies for the courtesy bonuses mentioned above when the distributor is being paid on front-line distributors. In other words, distributors are not eligible to receive the courtesy bonus based on the PV of distributors who are deeper in the genealogy than the front line.

It should also be pointed out that the Phase I commissions, as they have been described, are mutually exclusive. In other words, a TV of 1,000 would theoretically qualify a distributor for every level of Phase I commissions 310, 320, 330, and 340; however, the distributor can only receive the commissions from a single qualification level, which will be the highest level of commissions that a distributor is qualified to receive.

To further illustrate how Phase I commissions are computed, the Phase I commissions for the top-line distributor 210 of FIG. 2 will now be computed. Initially, the TV for distributor 210 must be known in order to identify the level of commissions that the distributor 210 is qualified to receive. As noted previously, the TV of distributor 210 is 1,485. A TV of 1,485 is greater than 1,000, thereby qualifying distributor 210 for a fourth-level, Phase I commission 340. Accordingly, the total Phase I commission for distributor 210 comprises a monetary equivalent of the sum of (20%-X%) of the PV of each team member and a courtesy bonus of 5% of the PV of each front line team member that has already received a personal rebate of at least 20%. Team members include distributor 212, distributor 214, and distributor 218. To determine the personal rebate for each of the team members, reference is made to table 100 of FIG. 1. In particular, distributor 212, having a PV of 1,100, qualifies for a 20% personal rebate; distributor 214, having a PV of only 55, does not qualify for a personal rebate; and distributor 218, having a PV of 150, qualifies for a 5% personal rebate.

Accordingly, the Phase I commission for distributor 210, in monetary equivalence, comprises the sum of (20%-20%) of the PV of distributor 212 (PV=1,100), or $0.00; (20%-0%) of the PV of distributor 214 (55), or $11.00; (20%-5%) of the PV of distributor 218 (PV=150), or $22.50; and a 5% courtesy bonus of the PV of front line distributor 212 (PV=1,100), or $55.00; thereby resulting in a grand total Phase I commission of $85.50.

As noted above, a distributor may also receive a commission on the PV of every distributor that is included in the distributor's “first generation.” The distributor's first generation includes: (1) all distributors on the top-line distributor's first line and (2) when a first line distributor is not “team qualified,” e.g., does not have a TV of at least 1,000, every downline distributor below any front-line distributor that is not team qualified, down to and including the first team qualified distributor encountered in that downline. A generation is delimited only by team qualified distributors, such that a generation includes all distributors located between the top-line distributor down to and including the first team qualified distributors encountered in each downline of the top-line distributor.

For example, according to this embodiment, top-line distributor 210 of FIG. 2 has a first generation that includes every downline distributor down to and including the first team qualified distributor encountered in each downline. In the present embodiment, distributor 210 has two downlines. The first comprises distributor 212 which is team qualified with a PV and TV of 1,100. The second downline comprises distributors 214, 218, 220, 222, and 224. To determine which of these distributors are included in the first generation, it is necessary to find the first team qualified distributor encountered in the downline.

Using the rules for computing TV discussed above, it is determined that distributor 214 has a TV that includes (1) the PV of distributor 214 (PV=55) and (2) the PV of every personally sponsored distributor of distributor 214, which includes distributor 218 (PV=150), for a total TV of 205, and is therefore inadequate for team qualification. Next, distributor 218 is found to have a TV that includes (1) the PV of distributor 218 (PV=150) and (2) the PV of personally sponsored distributor 220 (PV=40). Because distributor 220 is not personally qualified, e.g., does not have a PV of at least 100, the TV of distributor 218 also includes (3) the PV of downline distributor 222 (PV=160), resulting in a total TV of 350, which is inadequate for team qualification. Next, the TV of distributor 220 is computed, which includes (1) the PV of distributor 220 (PV=40) and (2) the PV of distributor 222 (PV=160), for a total TV of 200, which is inadequate for team qualification. Finally, the TV of distributor 222 is determined, which includes: (1) the PV of distributor 222 (PV=160) and (2) the PV of distributor 224 (PV=1,300), for a total TV of 1,460, which is adequate for team qualification. Hence, distributor 222 is the first team qualified distributor in the downline of first level distributor 214. Accordingly, the first generation of distributor 210 includes distributors 212, 214, 218, 220, and 222.

Phase I commissions will now be computed for top-line distributor 210 according to this embodiment in which commissions are paid to all distributors within the top-line distributor's first generation, as described above. According to this embodiment, distributor 210 will receive the commissions described above, totaling $85.50, plus additional commissions on the PV of distributors 220 and 222 because they are part of the first generation of distributor 210, as described above.

To determine how much of a commission distributor 210 will receive on the PV of distributor 220 and 222, it is necessary to determine the percentage of rebates and commissions paid out on the PV of distributors 220 and 222. To do this, it must first be considered that distributor 218 has a PV of 150 and TV of 350, as noted above, and is therefore qualified to receive a second-level commission 320 comprising a monetary equivalent of (10%-X) of the PV of distributor 220. Distributor 220 only has a PV of 40, and therefore is not qualified for a personal rebate, such that distributor 218 will receive a 10% payout on the PV of distributor 220. The next upline distributor, distributor 214 has a PV of only 55, and is therefore not qualified to receive a commission on distributor 220, Accordingly, the total percentage that is already paid out on the PV of distributor 220 is 10%. Therefore, distributor 210 will receive a commission comprising a monetary equivalent of (20%-10%) of the PV of distributor 220 (PV=40), which equals $4.00.

Next, it is necessary to determine the percentage of rebates and commissions that have already been paid out on the PV of distributor 222. Distributor 222 has a PV of 160 and is therefore qualified for a personal rebate of 5%. Distributors 214 and 220 are not qualified to receive a commission on the PV of distributor 222 because they each have a PV of less than 100, as noted above. Distributor 218, however, does qualify for a second-level rebate 320, having a TV of at least 350 and a PV of at least 150, and is therefore qualified for a commission of 10% minus the 5% rebate already paid to distributor 222. Accordingly, a total of 10% has been paid out on the PV of distributor 222. Therefore, distributor 210 is qualified to receive a commission comprising a monetary equivalent of (20%-10%) of the PV of distributor 222 (PV=160), or $16.00. Accordingly, the total Phase I commissions payable to distributor 210 on all first generation members comprises $85.50+$4.00+$16.00=$105.50.

It will be appreciated by one of skill in the art that the minimum team volumes to qualify for the various levels of Phase I commissions may be set at a variety of levels according to the desires and economics of the company implementing the plan of the present invention. Additionally, the percentages of PV of the team members utilized in calculating the Phase I commissions may also be varied according to the needs of the company implementing this plan, although it is generally preferred that a greater percentage be paid out for team members having a lower PV than for team members with a higher PV. In this embodiment, it is preferred that the total payout of Phase I commissions and rebates based on the PV of a single position not exceed 20 percent (excluding courtesy bonuses). In other words, the present plan permits a number of upline distributors to receive a Phase I commission based on the PV of a single downline distributor. The combination of these Phase I commissions plus the rebate received by the downline distributor should preferably not exceed 20 percent, excluding courtesy bonuses.

One feature of the present invention that is an advantage over the prior art is that the distributor is not penalized for the individual successes of the downline distributors. More particularly, there is no breakaway when a frontline or downline distributor becomes so successful so as to independently qualify for personal rebates, commissions, or other bonuses as described herein. Rather, the distributor's distribution genealogy remains intact, such that the frontline and downline distributors remain within the distributor's distribution genealogy so as to enable the distributor to receive the rebates and commissions the distributor is entitled to.

### PHASE II COMPENSATION

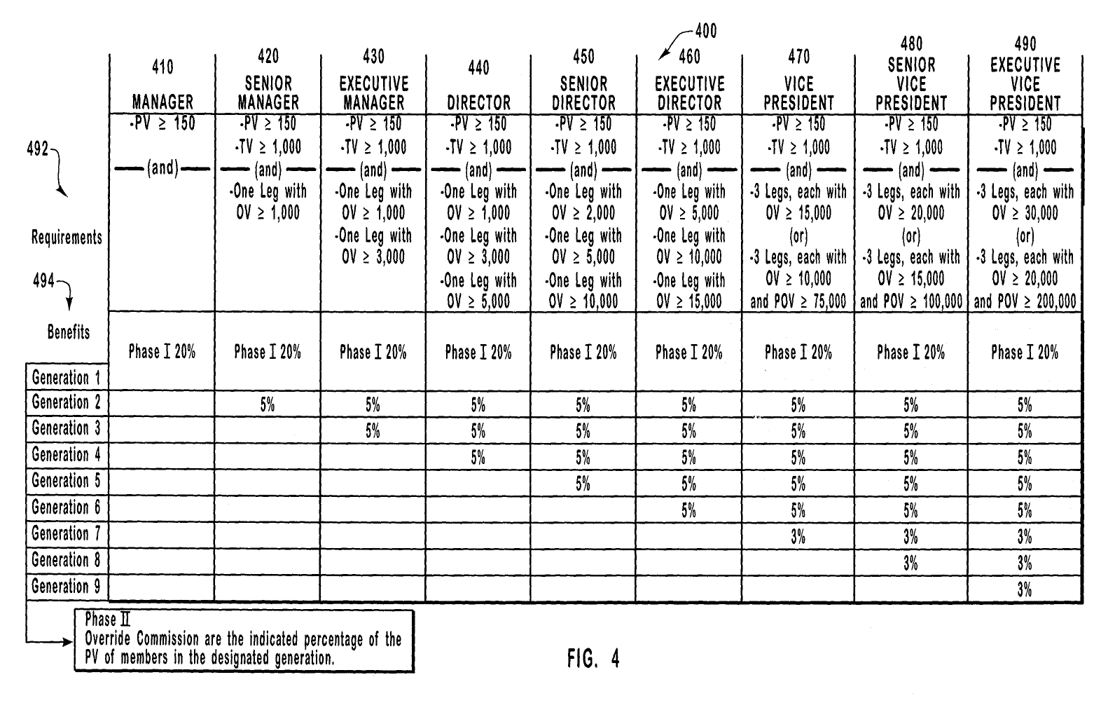

In accordance with the teachings of the present invention, Phase II compensation of the present invention generally includes an override commission that is paid to a distributor that satisfies a minimum TV requirement and a minimum leg requirement. According to one presently preferred embodiment of the invention, as illustrated in FIG. 4, there are nine override commission levels for which a distributor can qualify that are set forth in table 400, namely, Manager 410, Senior Manager 420, Executive Manager 430, Director 440, Senior Director 450, Executive Director 460, Vice President 470, Senior Vice President 480, and Executive Vice President 490. All of the override commission levels 410-490 are associated with corresponding requirements 492 and benefits 494.

The PV requirement for Phase II override commissions requires that the distributor have PV of at least 150. It should be appreciated that this requirement may be set at a variety of levels, according to the desires of those implementing this invention. The TV requirement for the Phase II override commission requires that the distributor have a TV of at least 1,000. A distributor's TV is computed the same way for Phase II as it is for Phase 1, as described above in reference to FIGS. 2-3. It should be appreciated, however, that the TV requirement can vary in amount or be eliminated entirely. For example, in one embodiment, Manager 410 does not have a minimum TV requirement.

The leg requirement of the Phase II override commission is generally described in terms of a required minimum number of legs with a minimum total PV requirement for each such leg. A leg is generally defined as the top-line distributor's personally sponsored distributors, in combination with the descendants (or downline distributors) of that position. For example, in FIG. 2 distributor 210 has two legs, a first leg comprising member 212 and a second leg that comprises distributor 214 in combination with distributors 218, 220, 222, and 224. A leg may comprise any number of descendent positions or alternatively, a leg may be limited in terms of levels or generations from the top-line distributor. According to a presently preferred embodiment, a leg includes all existing distributor descendents within the downline of a personally sponsored distributor. “Phase II generations,” as that term is used herein, refers to a “team qualified generation” and is determined according to Phase II compression rules, which will be described below.

The leg requirements to qualify for the various Phase II override commissions of the present invention are quantified in FIG. 4. These requirements are defined in terms of Organization Volume, or OV, requirements. The Organization Volume comprises the total leg volume of a single leg or, in other words, the total PV produced in a single leg of the top-line distributors distribution genealogy, as defined above. OV is thus computed by adding together the PV of every member within a given leg. For example, in FIG. 2, a first leg comprising distributor 212 has an OV of 1,100, which is the PV of distributor 212, the only distributor in the first leg. A second leg, comprising distributors 214, 218, 222, and 224, has an OV of 1,705, which is the sum total of the PV of every member in the second leg (e.g., 55+150+40+160+1,300).

As illustrated in FIG. 4, a top-line distributor having at least one leg with an OV of at least 1,000 qualifies for the Senior Manager override commission. A distributor having at least one leg with an OV of at least 1,000, and a second leg with an OV of at least 3,000 qualifies for the Executive Manager override commission. A distributor having at least one leg with an OV of at least 1,000, a second leg with an OV of at least 3,000, and a third leg with an OV of at least 5,000 qualifies for the Director override commission. A distributor having at least one leg with an OV of at least 2,000, one leg with an OV of at least 5,000, and a leg with an OV of at least 10,000 qualifies for the Senior Director override bonus. A distributor having at least one leg with an OV of at least 5,000, one leg with an OV of at least 10,000, and a leg with an OV of at least 15,000 qualifies for the Executive Director override commission.

A distributor having at least three legs, each with an OV of at least 15,000 qualifies for the Vice President override commission. In a presently preferred embodiment of the invention, a distributor can alternatively qualify for the Vice President override commission by having at least three legs, each with an OV of at least 10,000, and a personal organizational volume (“POV”) of at least 75,000, where the POV is computed by adding together the PV of every member of the distributor's distribution genealogy. Notably, in this preferred embodiment, POV includes the top-line distributor's own PV.

A distributor qualifies for the Senior Vice President override commission by having at least three legs, with each leg having an OV of at least 20,000, or alternatively by having at least three legs, with each leg having an OV of at least 15,000, and a POV of at least 100,000. Finally, a distributor qualifies for the Executive Vice President override commission by having at least three legs, with each leg having an OV of at least 30,000, or alternatively, by having at least three legs, with each leg having an OV of 20,000, and a POV of at least 200,000.

It will be appreciated that the magnitude of the OV and POV required to achieve the various levels of Phase II override commissions may be varied according to the needs of the company implementing this plan. Various qualification requirements may be imposed with greater benefits available as higher requirements are met. The specific numbers provided herein are merely exemplary and not intended to limit the scope of the present invention.

According to the preferred embodiment, the invention allows horizontal compression to be used to satisfy specific leg requirements. According to one embodiment of horizontal compression of the present invention, a distributor's largest leg is applied to the largest leg requirement, the distributors second largest leg is applied to the second largest requirement, and any remaining legs are horizontally compressed, or summed together, and applied to the last leg requirement. For example, if a distributor has (1) one leg comprising 16,000 OV, (2) one leg comprising 12,000 OV, and (3) four legs that each comprise 2,000 OV, the distributor qualifies for the leadership rank of Executive Director 460, assuming the distributor also has a PV of at least 150 and a TV of at least 1,000. The distributor qualifies for the rank of Executive Director 460 because its 16,000 OV leg satisfies the 15,000 leg OV requirement, its 12,000 OV leg satisfies the 10,000 leg OV requirement, and its remaining four 2,000 OV legs are horizontally compressed to equate 8,000 OV, thereby satisfying the 5,000 leg OV requirement.

To compute Phase II override commissions, it is first necessary to determine the Phase II generations for the top-line distributor, which are determined by performing compression of the distributor's genealogy. Generations under Phase II compensation are determined by analyzing each distributor's TV and determining, as a function of that TV, whether a generation break occurs between the distributor and the distributor's front line. If the TV of a distributor is less than 1,000, the distributor is not team qualified and no generation break occurs between that distributor and its front line. If the TV of a distributor is greater than or equal to 1,000 and the distributor has a PV of at least 150, the distributor is said to be team qualified and there is a generation break between the distributor and its front line. The TV of a distributor is determined, as discussed above, by summing the distributor's PV and the distributor's LV.

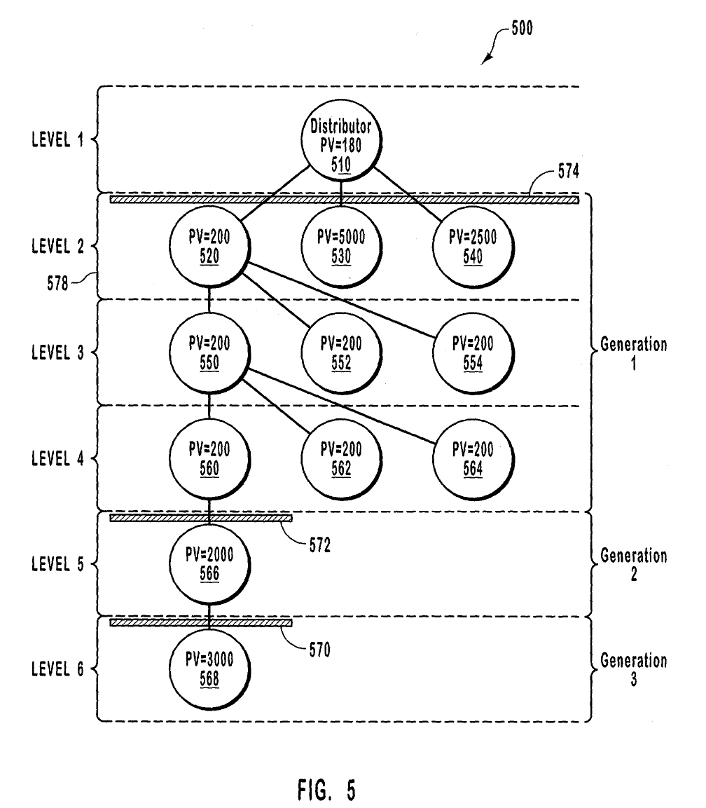

This analysis is best explained by reference to the sample distributor network illustrated in FIG. 5. At the bottom of the distributor network 500 in FIG. 5 is distributor 568. Because distributor 568 has sponsored no other distributors into the organization, it has no downline and therefore has no possibility of Phase II compression. Thus, the Phase II compression analysis begins with the lowest distributor to have a front line. In FIG. 5, this is distributor 566.

The first step in the Phase II compression analysis with respect to distributor 566 is to determine the TV of distributor 566 to ascertain whether distributor 566 is team qualified. This is done by adding the PV of distributor 566 to the LV of distributor 566. In this example, this calculation is simple because the LV of distributor 566 comprises the PV of only one distributor—distributor 568, with a PV of 3,000; thus, there are no other distributors in that generation to consider when calculating the TV of distributor 566. Hence, the TV of distributor 566 is the sum of the PV of distributor 566 (2,000) and the LV of distributor 566 (3,000), or 5,000.

Because 5,000 is above the threshold qualification level for team qualification (1,000) and because distributor 566 has 150 PV, distributor 566 is team qualified. Consequently, a generation break 570 occurs directly beneath distributor 566, thereby placing distributor 566 in a different generation from its front line (distributor 568).

Moving up the distribution network, the Phase II compression analysis can now be performed for distributor 560 by calculating the TV of distributor 560. The front line of distributor 560 includes only a single distributor, distributor 566. Having previously performed the Phase II compression analysis for distributor 566, it is known that a generation break 570 exists directly beneath distributor 566; hence, the only distributor in the generation that includes distributor 566 is distributor 566 itself. Adding the PV of distributor 566 (PV=2,000) and the PV of distributor 560 (PV=200) yields a TV for distributor 560 of 2,200, which is sufficient to render distributor 560 team qualified. Thus, a generation break 572 occurs beneath distributor 560, separating it from its downline distributor 566.

Continuing up the distributor network, the TV for distributor 550 may now be ascertained. This is done by first identifying the distributors in the front line of distributor 550. These include distributor 560, distributor 562, and distributor 564. The TV of distributor 550 is now determined by summing the PV of distributor 550 (PV=200) and the LV of distributor 550, which comprises the sum of the PV of distributor 560 (PV=200), distributor 562 (PV=200), and distributor 564 (PV=200), for a total TV of 800. This is below the amount necessary to team qualify distributor 550; thus, no generation break occurs between distributor 550 and its front line (distributors 560, 562, and 564).

Proceeding up the left hand side of the distribution network chart of FIG. 5, the Phase II compression analysis is now done for distributor 520. The front line of distributor 520 is identified, and includes distributor 550, distributor 552, and distributor 554. Because each of the front line distributors 550, 552, and 554 have a PV greater than 100, they are each personally qualified and no compression is required to compute the LV of distributor 520, which comprises the sum of the PV of distributor 550 (PV=200), distributor 552 (PV=200), and distributor 554 (PV=200), for a total LV of 600. Summing the PV of distributor 520 (PV=200) with the LV of distributor 520 (LV=600) yields a TV for distributor 520 of 800. This is insufficient to team qualify distributor 520; thus, no generation break occurs between distributor 520 and its front line (distributors 550, 552, and 554).

Continuing up the distribution network, it is now possible to compute the TV for distributor 510. As shown, distributor 510 has a front line that includes distributor 520 (PV=200), distributor 530 (PV=5,000), and distributor 540 (PV=2,500), for a LV of (200+5,000+2,500=7,700). Summing the PV of distributor 510 (PV=180) with the LV of distributor 510 (LV=7,700) yields 7,880, well above the threshold to team qualify distributor 510; thus, a generation break 574 occurs between distributor 510 and its front line (distributors 520, 530 and 540).

It should be noted that it is not necessary to conduct compression analysis for distributors 562, 564, 552, 554, 530, or 540, as none of these distributors has any downline. Consequently, like distributor 568, they have no possibility of Phase II compression. The generation calculation may be calculated working up the distribution organization as detailed in this example, or alternatively, by working down the organization, as described above in reference to FIG. 2, wherein it was shown how a generation includes the PV of all distributors located between the top-line distributor down to and including the first team qualified distributors encountered in each downline of the top-line distributor.

Once the Phase II generations have been identified according to the compression described above, it is possible to compute the override commissions for each leadership rank according to table 400 of FIG. 4. As shown in FIG. 4, each of the leadership ranks qualify for a “Phase I 20%” bonus for generation 1, which comprises all Phase I payments as previously described. Accordingly, the rank of Manager 400 is only qualified for Phase I rebates and commissions described above. A Senior Manager 420 qualifies for the override commission of a Manager 400 and an additional override commission comprising the monetary equivalent of 5% of the PV of every member in generation 2. An Executive Manager 430 qualifies for the override commission of a Senior Manager 420 plus an override commission comprising the monetary equivalent of 5% of the PV of every member in generation 3. A Director 440 qualifies for the override commission of an Executive Manger 430 plus an override commission comprising the monetary equivalent of 5% of the PV of every member in generation 4. A Senior Director 450 qualifies for the override commission of a Director 440 plus an override commission comprising the monetary equivalent of 5% of the PV of every member in generation 5. An Executive Director 460 qualifies for the override commission of a Senior Director 450 plus an override commission comprising the monetary equivalent of 5% of the PV of every member in generation 6. A Vice President 470 qualifies for the override commission of an Executive Director 460 plus an override commission comprising the monetary equivalent of 3% of the PV of every member in generation 7. A Senior Vice President 480 qualifies for the override commission of a Vice President 470 plus an override commission comprising the monetary equivalent of 3% of the PV of every member in generation 8. Finally, an Executive Vice President 490 qualifies for the override commission of a Senior Vice President 480 plus an override commission comprising the monetary equivalent of 3% of the PV of every member in generation 9.

Returning now to FIG. 5, the computation of the Phase II override commission for distributor 510 is explained. Initially, the leadership rank for which distributor 510 has qualified must be determined so that the corresponding benefits 494 distributor 510 is qualified to receive are known. As shown, top-line distributor 510 has three legs, one leg comprising only member 540 has an OV of 2,500, a second leg comprising only member 530 has an OV of 5,000, and a third leg comprising members 520, 550, 552, 554, 560, 562, 564, 566, and 568 has an OV of 6,400, which is the sum of the PV of every member of the leg. Accordingly, distributor 510 has three legs, having OVs of 2,500, 5,000, and 6,400, thereby qualifying for the Phase II rank and override bonus of Director 440 which requires that the distributor have a PV of 150, a TV of 1,000, one leg with an OV of at least 1,000, a second leg with an OV of at least 3,000, and a third leg with an OV of at least 5,000.

Now, using table 400 from FIG. 4, the distributor's Director bonus can be calculated, which is the monetary equivalent of the sum of 5% of the PV of all distributors in its second generation (distributor 566) and 5% of the PV of all distributors in its third generation (distributor 568), or (0.05×2,000)+(0.05×3,000) $250.00. Although distributor 510 as a Director is entitled to also receive a 5% bonus for the PV of any distributors in its fourth generation, in this example there are no fourth generation distributors.

According to this presently preferred embodiment of the Phase II compensation of the present invention, a Senior Director qualifies for an additional bonus of $200 for having a POV of at least 25,000. An Executive Director qualifies for an additional bonus of $300 for having a POV of at least 35,000. A Vice President qualifies for an additional bonus of $400 for having a POV of at least 50,000. A Senior Vice President qualifies for an additional bonus of $500 for having a POV of at least 90,000. An Executive Vice President qualifies for an additional bonus of $750 for having a POV of at least 110,000.

Although specific dollar amounts have been given regarding POV requirements and additional bonus amounts, it should be appreciated that different dollar amounts can be used. The additional bonus can also include other perks, such as airfare, vacation packages, dinner vouchers, entertainment vouchers, etc. This bonus may also be accrued for use at a later time for company-sponsored events or other purposes approved by the company.

According to another embodiment, the additional bonus comprises money that must be spent on a car purchase or a car lease payment. To ensure the additional bonus is used as required, the distributor may be required to submit documentation of a car purchase or lease.

According to yet another embodiment, distributors that qualify for a leadership rank may also receive shares in a global bonus pool. The global bonus pool comprises a percentage of the total PV of all distributors in the company's entire sales organization. In one presently preferred embodiment of the invention, the global bonus pool comprises a monetary equivalent of 2% of the PV of all distributors of the organization. Thus, a share in the global bonus pool entitles the owner of that share to a portion of the pool equal to the number of shares earned by the distributor divided by the total shares in the global bonus pool held by all distributors.

According to one implementation of the present embodiment, an Executive Director 460 is granted one share in the global bonus pool, a Vice President 470 is granted two shares in the global bonus pool, a Senior Vice President 480 is granted three shares in the global bonus pool, and an Executive Vice President 490 is granted one share in the global bonus pool. When paying bonuses out of the global bonus pool, one dollar is preferably paid out for each point of PV in the pool.

### PHASE III COMPENSATION

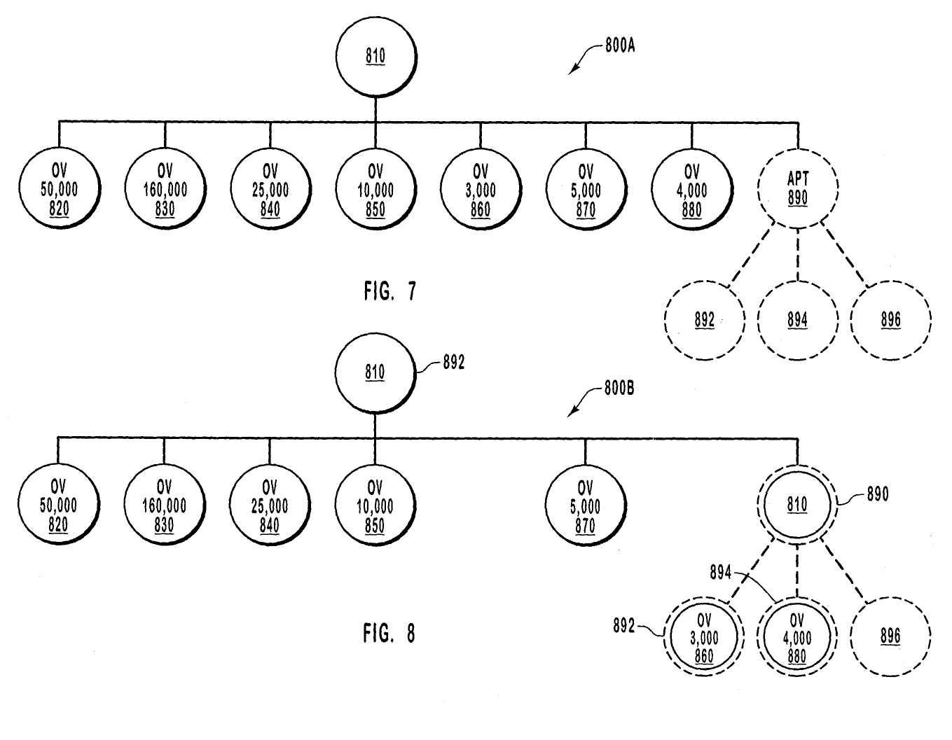

The compensation plan of the present invention also preferably includes a component of what is referred to herein as Phase III compensation. In accordance with the teachings of the present invention, there are four general Phase III compensation levels, which are referred to herein as “clubs.” As illustrated in table 700 of FIG. 7, these Phase III clubs include the Royal Executive Club 710, the Royal Sapphire Club 720, the Royal Ruby Club 730, and the Royal Diamond Club 740. The compensation levels along with the corresponding requirements 750 and benefits 760 are also shown in table 700 of FIG. 7.

In a presently preferred embodiment of the invention, a distributor must satisfy one of two requirements to qualify for the Royal Executive Club 710 in conjunction with having 150 PV and 1000 TV. The first requirement is to have three legs, with each leg having an OV of at least 40,000. The second requirement is to have a POV of at least 250,000 and three legs each having an OV of at least 25,000. It should be appreciated, however, that other requirements can also be imposed, such as, for example, requiring compliance with either of the first two requirements for a period of three consecutive months.

A distributor that is qualified for the Royal Executive Club is entitled to four shares of the Global Bonus Pool. The distributor is also entitled to create one additional performance team (“APT”) position. An APT position is a position on the top-line distributor's front line that is occupied by the top-line distributor. In one embodiment, the APT position also includes an option for the distributor to transfer up to three existing legs beneath the newly created APT position. The APT position is particularly beneficial for a distributor that chooses to occupy the APT position by itself because the distributor can then receive double Phase II and Phase III override commissions on certain members of the distributor's genealogy that descend from the APT position. The benefits associated with an APT position and the methods for establishing an APT position will be more fully explained in reference to FIGS. 7-8.

FIG. 7 illustrates a sample genealogy 800A in which a distributor 810 has seven legs 820, 830, 840, 850, 860, 870, and 880. In this example, the POV of distributor 810 is 257,000, which is calculated by summing the OVs of each of the legs of distributor 810 (50,000+160,000+25,000+10,000+3,000+5,000+4,000). Because the POV of distributor 810 exceeds 250,000 and three of those legs have an OV of at least 25,000, distributor 810 is qualified for the Royal Executive Club 710, and hence is entitled to an APT position.

In FIG. 7, APT position 890 is drawn in broken lines, indicating that the position is available to be filled, along with these potential transfer leg positions 892, 894, and 896. In this example, the distributor 810 fills the APT position 890 with itself, as shown in FIG. 8. Also shown in FIG. 8, the distributor 810 has transferred two existing legs 860 and 880 to occupy two of the transfer leg positions 892 and 894. The total leg OV between legs 860 and 880 is 7,000 (e.g. 3,000+4,000). Distributor 810 may also build other positions on the front line of APT 890 by sponsoring additional distributors into the company.

According to the new genealogy 800B illustrated in FIG. 8, the distributor 810 is now eligible to receive two sets of Phase II override commissions on legs 870 and 880, one from the distributor's original position 892 and one from the APT position 890. Accordingly, it is beneficial for the distributor 810 to fill the APT descendent leg positions 892, 894, and 896 with those existing legs that have the highest OV, thereby maximizing the OV on which distributor 810 will earn double bonus commissions.

According to one embodiment of the present invention, the distributor can only fill the APT transfer leg positions 892, 894, 896 with legs that have a combined leg OV of 10,000 or less. According to this embodiment, APT transfer leg position 896 cannot be filled with leg 870 because the result would be a total leg OV of 12,000 (i.e., 3,000+4,000+5,000). According to another embodiment, the distributor can transfer any number of legs under the APT position.

According to yet another embodiment of Phase III compensation, the distributor is only eligible for an APT position if the distributor can qualify for the APT position without considering the OV of the legs it transfers beneath the APT position 890. In accordance with this alternative embodiment of the invention, distributor 810 in FIG. 7 cannot fill any of the APT transfer legs 892, 894, or 896 with any leg having an OV of $7,000 or more. Thus, for example, distributor 810 would be precluded from transferring leg 850 below the APT position 890 because that would reduce the distributor's POV (excluding the OV of the APT position) to only 247,000 (i.e., 50,000+160,000+25,000+3,000+5,000+4,000). With a POV of only 247,000, the distributor would fail to qualify for the Royal Executive Club and would not be entitled to the corresponding APT bonus position.

It should also be appreciated that there are various limits and requirements that can be placed on an APT position. The foregoing embodiments are only given as a matter of illustration and should not be construed as limiting the scope of the present invention, Once an APT position is established on a distributor's genealogy, it is possible for the occupant of the APT position to independently qualify for an APT position of its own by satisfying the designated requirements of a corresponding Phase III compensation level.

To qualify for the Royal Sapphire Club 720 a distributor must satisfy one of two requirements in conjunction with having 150 PV and 1,000 TV. The first requirement is to have at least three legs, with each leg having an OV of at least 50,000. The second, alternative, requirement is that the distributor must have a POV of at least 300,000 and at least three legs that each leg have an OV of at least 30,000. When a distributor qualifies for the Royal Sapphire Club 720, the distributor is eligible to maintain its APT position, as described above, an override commission comprising the monetary equivalent of 1% of the PV of every member in generation 10 of the Phase II compression, and four shares in the global bonus pool.

To qualify for the Royal Ruby Club 730, a distributor must have 150 PV, 1,000 TV, and one of either three legs, each having an OV of at least 100,000, or, alternatively, a POV of 500,000 and three legs, each of which has an OV of at least 50,000. When a distributor qualifies for the Royal Ruby Club 730, the distributor is eligible to maintain its APT position, an override commission comprising the monetary equivalent of 1% of the PV of every member in generation 10 and generation 11 of the distributor's Phase II genealogy, and four shares in the global bonus pool.

To qualify for the Royal Diamond Club 740, a distributor must have either three legs, with each leg having an OV of at least 250,000, or, alternatively, the distributor must have a POV of 1,000,000 and three legs, with each leg having an OV of at least 100,000. When a distributor qualifies for the Royal Diamond Club 740, the distributor is eligible to maintain its APT position, an override bonus comprising the monetary equivalent of 1% of the PV of every member in the distributor's Phase II generations 10, 11, and 12, and four shares in the global bonus pool.

In an alternative embodiment of Phase III compensation, the alternative requirements for club membership that require three legs each having a predetermined OV and a POV of a specified amount is modified. In this alternative embodiment, the POV requirements must be reached exclusive of the TV of the three legs used in meeting the other portion of the club qualification requirement. Thus, for example, to qualify for Royal Executive Club 710, illustrated in FIG. 7, under the alternative requirements of three legs each having an OV of at least 25,000 and a POV of at least 250,000, this requirement would be interpreted as requiring that the POV component of the requirement be satisfied independently of the three legs used to satisfy the other component of the requirement.

According to another embodiment, the leg requirements for any of the aforementioned Phase III club levels can be satisfied by using horizontal compression, as described above in reference to FIG. 4. However, according to one presently preferred embodiment, if an APT position is required to be used during horizontal compression to qualify a distributor for a Phase III club level because the distributor would not otherwise qualify for a Phase III club level, then that distributor is not eligible to receive the benefit of the APT position for other than qualification to the corresponding club level. In particular, an APT position that is required to be used during horizontal compression to maintain a distributor's qualification for a particular club level is not eligible to receive any earnings.

Qualifying for any of the aforementioned Phase III compensation levels can also be contingent on a distributor satisfying the designated requirements over a period of time, such as three or six consecutive months. According to other embodiments, a distributor that qualifies for membership in a phase III leadership club will receive a one-year membership in the designated club. For example, if a distributor qualifies for the Royal Executive Club 710 by satisfying the corresponding requirements, then the distributor will be granted a one-year membership in the Royal Executive Club 710, entitling the distributor to all of the benefits that are associated with the Royal Executive Club 710 for the one-year membership period.

According to another embodiment, however, a distributor is required to continue satisfying all of the requirements of a leadership club in order to receive all of the benefits of the club. For example, even with membership to the Royal Executive Club 710, a distributor must satisfy the corresponding Royal Executive Club requirements 750 each month in order to receive and maintain an APT.

According to yet another embodiment, entitlement to the 1% override bonuses and shares in the Global Bonus Pool is contingent on satisfying corresponding club requirements on a discrete monthly basis (i.e., the corresponding club requirements must be met for the month in which the override bonus and Global Bonus Pool shares are earned), while entitlement to official recognition and APT positions is contingent on having satisfied their corresponding requirements over a period of three consecutive months.

Qualification to a designated Phase III compensation level can also be predicated upon a sliding scale. To illustrate this point, an example will be given in which a distributor receives a one-year membership for satisfying the requirements of a designated compensation level for three consecutive months, as required. According to this example, the distributor qualifies for club membership by satisfying the designated requirements from month one to month three, such that the membership will expire in month fifteen. However, if the distributor also satisfies the designated requirements in months four and five, then the effective starting date of the membership will slide to month five, such that the membership will not expire until month seventeen.

Although numerous examples have been given, in which great detail is provided, it should be appreciated that the examples, as they have been provided, should be construed as illustrative and not limiting of the invention. In particular, the present invention can be embodied in other specific forms without departing from its spirit or essential characteristics. For example, the names, requirements and benefits associated with each of the three phases of the network marketing compensation system can vary. In particular, it should be appreciated that each of the aforementioned Phase III compensation levels can also be configured to include special recognition and other perks.

It should also be appreciated that the present invention may be embodied in other forms without departing from its spirit or essential characteristics. As properly understood, the preceding description of specific embodiments is illustrative only and in no way restrictive. The scope of the invention is, therefore, indicated by the appended claims as follows.

What is claimed is:

1. A method for compensating a distributor participating in a direct sales organization for developing a distribution genealogy that includes frontline distributors that are personally sponsored by the distributor and downline distributors that descend from at least one of the frontline distributors, the distributor's distribution genealogy further including a plurality of legs, wherein each leg includes one of the frontline distributors and any downline distributors descending from that frontline distributor, the method including the steps of:
calculating and paying a personal rebate to the distributor for having a personal volume that satisfies a personal volume requirement, the personal rebate comprising a percentage of the distributor's personal volume, where the distributor's personal volume comprises a total amount of commissionable units of product purchased by the distributor within a first period of time; and
calculating and paying a first commission to the distributor for having a team volume that satisfies a team volume requirement, wherein the distributor's team volume includes the sum of the distributor's personal volume and a personal volume for each one of a plurality of team members, said plurality of team members including the frontline distributors, said personal volume for each team member comprising a total amount of commissionable units of product purchased by said team member within said first period of time,
wherein said first commission comprises a percentage of the personal volume of each of the team members, and
wherein each frontline distributor can sponsor any number of downline distributors that can each sponsor any number of additional downline distributors, such that each frontline distributor can independently qualify for said personal rebate and said first commission, and wherein each frontline distributor remains within the distributor's distribution genealogy for purposes of calculating and paying the distributor said rebate and said first commission regardless of whether any said frontline and downline distributors independently qualify for said rebate and said first commission.

2. A method for compensating a distributor as recited in claim 1, wherein said first commission is calculated individually for each team member based on the personal volume of said team member.

3. A method for compensating a distributor as recited in claim 2, wherein said first commission includes four mutually exclusive payment levels that correspond with team volume requirements and personal volume requirements, and wherein the distributor qualifies for one of the four payment levels upon satisfying a team volume requirement and a personal volume requirement that correspond with one of the four mutually exclusive payment levels, said payment levels, team volume requirements and personal volume requirements set forth in the following table:

| Team Volume | Personal Volume | First Commission To Be Paid |
|---|---|---|
| Requirement | Requirement | To The Distributor |
| W | AA | (P % minus X %) of the personal |
| | | volume of each Team Member |
| X | BB | (Q % minus X %) of the personal |
| | | volume of each Team Member |
| Y | CC | (R % minus X %) of the personal |
| | | volume of each Team Member |
| Z | DD | (S % minus X %) of the personal |
| | | volume of each Team Member |

wherein X% is a percentage of each team member's personal volume that is paid to said team member in the form of personal rebates and first commissions based upon independent qualifications of each team member for said personal rebates and first commissions.

4. A method for compensating a distributor as recited in claim 3, wherein W is a team volume of at least 1000, wherein X is a team volume of between 700 and 999, wherein Y is a team volume of between 350 and 699, wherein Z is a team volume of between 100 and 349.

5. A method for compensating a distributor as recited in claim 3, wherein AA is a personal volume of about 150, wherein BB is a personal volume of about 100, wherein CC is a personal volume of about 100, and wherein DD is a personal volume of about 100.

6. A method for compensating a distributor as recited in claim 3, wherein P% comprises 20%, wherein Q% comprises 15%, wherein R% comprises 10%, and wherein S% comprises 5%.

7. A method for compensating a distributor as recited in claim 1, wherein a downline member sponsored by a team member of the distributor is also considered a team member of the distributor when the team member sponsoring the downline member has a personal volume that fails to satisfy a minimum personal volume requirement.

8. A method for compensating a distributor as recited in claim 7, wherein the minimum personal volume requirement is a personal volume of 100.

9. A method for compensating a distributor as recited in claim 1, wherein the first commission includes a courtesy bonus paid to a distributor having a personal volume of at least 100 and a team volume that satisfies a team volume requirement according to the following table:

| Team Volume | |
|---|---|
| Requirement | Courtesy Bonus To Be Paid To The Distributor |
| W | AA % of the personal volume of each Frontline Member |
| | who has received a personal rebate of P % of the their |
| | own personal volume |
| X | AA % of the personal volume of each Frontline Member |
| | who has received a personal rebate of Q % of the their |
| | own personal volume |
| Y | AA % of the personal volume of each Frontline Member |
| | who has received a personal rebate of R % of the their |
| | own personal volume |
| Z | AA % of the personal volume of each Frontline Member |
| | who has received a personal rebate of S % of the their |
| | own personal volume |

10. A method for compensating a distributor as recited in claim 9, wherein W comprises a team volume of at least 1000, a team volume of at least 700, wherein Y comprises a team volume of at least 350, and wherein Z comprises a team volume of at least

11. A method for compensating a distributor as recited in claim 10, wherein AA% comprises 5%, wherein P% comprises 20%, wherein Q% comprises 15%, wherein R% comprises 10%, and wherein S% comprises 5%.

12. A method for compensating a distributor as recited in claim 1, wherein the commissionable units are U.S. dollars, such that personal volume comprises the total dollar value of product purchased during the first period of time.

13. A method for compensating a distributor as recited in claim 1, wherein said first period of time is one calendar month.

14. A method for compensating a distributor as recited in claim 1, further including the step of paying the distributor for an override bonus comprising a percentage of the personal volume of each downline distributor within the distributor's distribution genealogy when the distributor satisfies minimum override bonus requirements according to the following override bonus table:

| | Generation of Distributor's Distribution | | | | | | | |
|---|---|---|---|---|---|---|---|---|
| | Genealogy and Percentages of the Personal | | | | | | | |
| | Volume Paid on the Personal Volume of | | | | | | | |
| | Each Downline Distributor In Each of Said | | | | | | | |
| | Generations: | | | | | | | |
| Minimum Override Bonus Requirements | 2nd | 3rd | 4th | 5th | 6th | 7th | 8th | 9th |
| A leg comprising a leg volume of AA | X % | | | | | | | |
| A first leg comprising a leg volume of AA and a | X % | X % | | | | | | |
| second leg comprising a leg volume of BB | | | | | | | | |
| A first leg comprising a leg volume of CC, a | X % | X % | X % | | | | | |
| second leg comprising a leg volume of DD, and a | | | | | | | | |
| third leg comprising a leg volume of EE | | | | | | | | |
| A first leg comprising a leg volume of FF, a second | X % | X % | X % | X % | | | | |
| leg comprising a leg volume of GG, and a third leg | | | | | | | | |
| comprising a leg volume of HH | | | | | | | | |
| A first leg comprising a leg volume of II, a second | X % | X % | X % | X % | X % | | | |
| leg comprising a leg volume of JJ, and a third leg | | | | | | | | |
| comprising a leg volume of KK | | | | | | | | |
| Three legs, each leg comprising a leg volume of LL | X % | X % | X % | X % | X % | Y % | | |
| Three legs, each leg comprising a leg volume of | X % | X % | X % | X % | X % | Y % | | |
| MM, and a total organizational volume of NN | | | | | | | | |
| Three legs, each leg comprising a leg volume of OO | X % | X % | X % | X % | X % | Y % | Y % | |
| Three legs, each leg comprising a leg volume of | X % | X % | X % | X % | X % | Y % | Y % | |
| PP, and a total organizational volume of QQ | | | | | | | | |
| Three legs, each leg comprising a leg volume of RR | X % | X % | X % | X % | X % | Y % | Y % | Y % |
| Three legs, each leg comprising a leg volume of | X % | X % | X % | X % | X % | Y % | Y % | Y % |
| SS, and a total organizational volume of TT | | | | | | | | |

wherein AA, BB, CC, DD, EE, FF, GG, HH, II, JJ, KK, LL, MM, NN, OO, PP, QQ, RR, SS, and TT comprise predetermined leg volumes, each leg volume comprising the total amount of commissionable units of product purchased by a corresponding leg within said first period of time,
wherein X% and Y% comprise predetermined percentages of a downline distributor's personal volume which is paid to the distributor as part of the override bonus according to the override bonus table, and
wherein said total organizational volume comprises the total amount of commissionable units of product purchased by said distributor and said distributor's distribution genealogy within said first period of time

15. A method for compensating a distributor as recited in claim 14, wherein X% comprises 5% and wherein Y% comprises 3%.

16. A method for compensating a distributor as recited in claim 14, wherein AA comprises 1,000, BB comprises 1,000, CC comprises 3,000, DD comprises 1,000, EE comprises 3,000, FF comprises 5,000, GG comprises 2,000, HH comprises 5,000, II comprises 10,000, JJ comprises 5,000, KK comprises 10,000, LL comprises 15,000, MM comprises 10,000, NN comprises 75,000, OO comprises 20,000, PP comprises 15,000, QQ comprises 100,000, RR comprises 30,000, SS comprises 20,000, and TT comprises 200,000.

17. A method for compensating a distributor as recited in claim 14, wherein the minimum override bonus requirements include a plurality of leg volume requirements that can be satisfied by performing the step of horizontal compression, horizontal compression comprising the act of summing leg volumes of at least two legs to obtain a combined leg volume that satisfies a minimum leg volume requirement.

18. A method for compensating a distributor as recited in claim 17, wherein the distributor's distribution genealogy includes a first leg having a largest leg volume, a second leg having a second largest leg volume and a plurality of remaining legs that each have a corresponding leg volume, and wherein horizontal compression includes the acts of:
applying the first leg to a first leg volume requirement,
applying the second leg to a second leg volume requirement, and
applying a combination of the remaining legs to a final leg volume requirement.

19. A method for compensating a distributor as recited in claim 14, wherein the distributor qualifies for the override bonus upon satisfying minimum personal volume and team volume requirements.

20. A method for compensating a distributor as recited in claim 19, wherein the minimum personal volume requirement is at least 150, and wherein the minimum team volume requirement is at least 1000.

21. A method for compensating a distributor as recited in claim 14, further including the step of providing the distributor a club bonus for satisfying a predetermined total organization requirement and predetermined leg volume requirement, wherein the club bonus includes an additional performance team position that includes a position on the distributor's frontline that is filled by one of the distributor and another person selected by the distributor.

22. A method for compensating a distributor as recited in claim 21, wherein the club bonus entitles the distributor to move at least one preexisting leg of the distributor's distribution genealogy below the additional performance team position.

23. A method for compensating a distributor as recited in claim 21, wherein the club bonus entitles the distributor to at least one share of a global bonus pool, wherein the global bonus pool comprises a monetary equivalent of a predetermined percentage of the personal volume of all distributors and members participating in the compensation plan, such that a share of the global bonus pool entitles the distributor to a portion of the global bonus pool that is equal to the global bonus pool divided by a total number of global bonus pool shares that are distributed to qualified distributors.

24. A method for compensating a distributor as recited in claim 23, wherein the predetermined percentage of personal volume is 2%.

25. A method for compensating a distributor as recited in claim 21, wherein a distributor must requalify for a club bonus on a monthly basis.

26. A method for compensating a distributor as recited in claim 21, wherein the total organization requirement includes a requirement for the distributor's distribution genealogy to purchase at least 250,000 commissionable units of product within said first period of time.

27. A method for compensating a distributor as recited in claim 26, wherein the predetermined leg volume requirement is a requirement for the distributor's distribution genealogy to include at least one of the following:
at least three legs, each leg purchasing at least X commissionable units of product during the predetermined period of time; and
at least three legs, each leg purchasing at least Y units of product during the predetermined period of time.

28. A method for compensating a distributor as recited in claim 27, wherein X is 40,000 and wherein Y is 25,000.

29. A method for compensating a distributor in a direct sales organization for developing a distribution genealogy that includes a plurality of legs, each leg including a frontline distributor that is personally sponsored by the distributor and may include downline distributors descending from the frontline distributor, wherein the frontline distributors and any downline distributors can sponsor additional downline distributors within the distributor's distribution genealogy, the method including the steps of:
paying a personal rebate to the distributor for satisfying a personal volume requirement, the personal rebate comprising a percentage of the distributor's personal volume, and wherein the distributor's personal volume comprises the total commissionable units of product purchased by the distributor within a predetermined period of time;
paying a commission to the distributor for satisfying a minimum team volume requirement, the commission including a percentage of the commissionable units of product that are purchased by each of a plurality of team members within the predetermined period of time, the distributor's team volume including the sum of the distributor's personal volume and the personal volume of each team member of the distributor,
wherein each frontline distributor is a team member and wherein any downline distributor sponsored by a team member is considered a team member when the sponsor of the downline distributor has a personal volume that fails to satisfy a minimum personal volume requirement; and
providing an additional performance team position to the distributor for satisfying the minimum personal volume requirement and a minimum team volume requirement during the predetermined period of time,
wherein the additional performance team position is a position on the distributor's frontline that is occupied by the distributor, and wherein the distributor is permitted to move at least one preexisting leg of the distributor's sales organization below the additional performance team position to thereby enable the distributor to receive rebates and commissions from the additional performance team position.

30. A method for compensating a distributor as recited in claim 29, wherein the distributor qualifies for the additional performance team position upon having a distribution genealogy that includes at least one of the following:
at least three legs, each leg purchasing at least X commissionable units of product during the predetermined period of time; and
at least three legs, each leg purchasing at least Y units of product during the predetermined period of time, and a total personal organizational volume of at least Z, wherein the total personal organizational volume comprises the total commissionable units of product purchased by the distributor's distribution genealogy during the predetermined period of time.

31. A method for compensating a distributor as recited in claim 30, wherein X is 40,000, wherein Y is 25,000, and wherein Z is 250,000.

32. A method for compensating a distributor as recited in claim 30, wherein the commissionable units are U.S. dollars, such that personal volume comprises the total dollar value of product purchased during the predetermined period of time.

33. A method for compensating a distributor as recited in claim 29, wherein the minimum personal volume requirement is at least 150, and wherein the minimum team volume requirement is at least 1000.

34. A method for compensating a distributor as recited in claim 29, wherein the predetermined period of time is one calendar month.

35. A method for compensating a distributor in a direct sales organization for developing a distribution genealogy that includes a plurality of legs, each leg including a frontline distributor that is personally sponsored by the distributor and may include downline distributors descending from the frontline distributor, wherein the frontline distributors and any downline distributors can sponsor additional downline distributors within the distributor's distribution genealogy, the method including the steps of:
paying a personal rebate to the distributor for satisfying a personal volume requirement, the personal rebate comprising a percentage of the distributor's personal volume, and wherein the distributor's personal volume comprises the total commissionable units of product purchased by the distributor within a predetermined period of time;
paying a commission to the distributor for satisfying a team volume requirement, the commission including a percentage of the commissionable units of product that are purchased by each of a plurality of team members within the predetermined period of time, the distributor's team volume including the sum of the distributor's personal volume and the personal volume of each team member of the distributor,
wherein each frontline distributor is a team member and wherein any downline distributor sponsored by a team member is considered a team member when the sponsor of the downline distributor has a personal volume that fails to satisfy a minimum personal volume requirement;
paying an override bonus to the distributor for satisfying a minimum override bonus requirement, the minimum override bonus requirement including:
a personal volume requirement;
a team volume requirement; and
a leg requirement for having a predetermined number of legs that each have a predetermined leg volume, leg volume comprising the total commissionable units of product purchased by the leg during the predetermined period of time; and
using horizontal compression to satisfy the leg requirement, wherein horizontal compression includes the act of combining leg volumes from a plurality of legs in the distributor's distribution genealogy to obtain a combined leg volume that satisfies a predetermined leg volume requirement.

36. A method for compensating a distributor as recited in claim 35, wherein the leg requirement includes having three legs, one leg comprising a first leg volume, one leg comprising a second leg volume, and one leg comprising a third leg volume.

37. A method for compensating a distributor as recited in claim 36, wherein the distributor qualifies for the override bonus by having a first leg comprising at least the first leg volume, a second leg comprising at least the second leg volume, and a plurality of other legs that together comprise at least the third leg volume.

38. A method for compensating a distributor as recited in claim 35, further including the step of providing an additional performance team position to the distributor within the distributors distribution genealogy that is occupied by the distributor and that entitles the distributor to receive rebates and commissions from the additional performance team position.

39. A method for compensating a distributor as recited in claim 35, wherein the commissionable units are U.S. dollars, such that personal volume comprises the total dollar value of product purchased during the predetermined period of time.

40. A method for compensating a distributor as recited in claim 35, wherein the minimum personal volume requirement is at least 150, and wherein the minimum team volume requirement is at least 1000.

41. A method for compensating a distributor as recited in claim 35, wherein the predetermined period of time is one calendar month.
